(19) United States
(12) Patent Application Publication
(10) Pub. No.: US 2011/0004510 A1
(43) Pub. Date: Jan. 6, 2011

(54) CAUSAL PRODUCT DEMAND FORECASTING SYSTEM AND METHOD USING WEATHER DATA AS CAUSAL FACTORS IN RETAIL DEMAND FORECASTING

(76) Inventors: Arash Bateni, Toronto (CA); Edward Kim, Toronto (CA)

Correspondence Address: JAMES M. STOVER;TERADATA CORPORATION, 2835 MIAMI VILLAGE DRIVE, MIAMISBURG, OH, 45342, US

(21) Appl. No.: 12/512,071

(22) Filed: Jul. 30, 2009

Related U.S. Application Data
(60) Provisional application No. 61/222,351, filed on Jul. 1, 2009.

(51) Int. Cl. G06Q 10/00; G06F 17/30; G06N 5/02; G06Q 50/00

(52) U.S. Cl. 705/10; 706/52; 707/778; 707/912; 707/955; 707/812

(57) ABSTRACT

A method system for forecasting product demand using a causal methodology, based on multiple regression techniques. The methodology utilizes weather related data as a set of causal factors for retail demand forecasting. These weather related factors may include temperature, precipitation, snow, accumulated snow, or extreme weather conditions.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/222,351, entitled “CAUSAL PRODUCT DEMAND FORECASTING SYSTEM AND METHOD USING WEATHER DATA AS CAUSAL FACTORS IN RETAIL DEMAND FORECASTING”; filed on Jul. 1, 2009 by Arash Bateni and Edward Kim.

This application is related to the following co-pending and commonly-assigned patent applications, which are incorporated by reference herein:

Application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger;

Application Ser. No. 11/938,812, entitled “IMPROVED METHODS AND SYSTEMS FOR FORECASTING PRODUCT DEMAND DURING PROMOTIONAL EVENTS USING A CAUSAL METHODOLOGY,” filed on Nov. 13, 2007, by Arash Bateni, Edward Kim, Harmintar Atwal, and J. P. Vorsanger;

Application Ser. No. 11/967,645, entitled “TECHNIQUES FOR CAUSAL DEMAND FORECASTING,” filed on Dec. 31, 2007, by Arash Bateni, Edward Kim, J. P. Vorsanger, and Rong Zong; and

Application Ser. No. 12/255,696, entitled “METHODOLOGY FOR SELECTING CAUSAL VARIABLES FOR USE IN A PRODUCT DEMAND FORECASTING SYSTEM,” filed on Oct. 22, 2008, by Arash Bateni and Edward Kim.

### FIELD OF THE INVENTION

The present invention relates to methods and systems for forecasting product demand using a causal methodology, based on multiple regression techniques, and in particular to the inclusion of weather related data as a set of causal factors for forecasting product demand using a causal methodology.

### BACKGROUND OF THE INVENTION

Accurate demand forecasts are crucial to a retailer's business activities, particularly inventory control and replenishment, and hence significantly contribute to the productivity and profit of retail organizations.

Teradata Corporation has developed a suite of analytical applications for the retail business, referred to as Teradata Demand Chain Management (DCM), which provides retailers with the tools they need for product demand forecasting, planning and replenishment. Teradata Demand Chain Management assists retailers in accurately forecasting product sales at the store/SKU (Stock Keeping Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

In application Ser. Nos. 11/613,404; 11/938,812; and 11/967,645, referred to above in the CROSS REFERENCE TO RELATED APPLICATIONS, Teradata Corporation has presented improvements to the DCM Application Suite for forecasting and modeling product demand during promotional and non-promotional periods. The forecasting methodologies described in these references seek to establish a cause-effect relationship between product demand and factors influencing product demand in a market environment. Such factors may include current product sales rates, seasonality of demand, product price changes, promotional activities, competitive information, and other factors. A product demand forecast is generated by blending the various influencing causal factors in accordance with corresponding regression coefficients determined through the analysis of historical product demand and factor information. Described below is an improvement to the causal demand forecasting methodology described above through the inclusion of weather related data as a new set of causal factors for retail demand forecasting.

### BRIEF DESCRIPTION OF THE DRAWINGS

FIG. 1 provides a high level architecture diagram of a web-based three-tier client-server computer system architecture.

FIG. 2 is a flow diagram illustrating an improved causal methodology for determining product demand forecasts including weather related data as a set of causal factors within the regression analysis and demand forecast calculations.

FIG. 3 illustrates a process for the selection of causal variables for product groups within a product hierarchy.

FIG. 4 illustrates an exemplary product hierarchy.

FIG. 5 shows a simplified output of this selection process of FIG. 4.

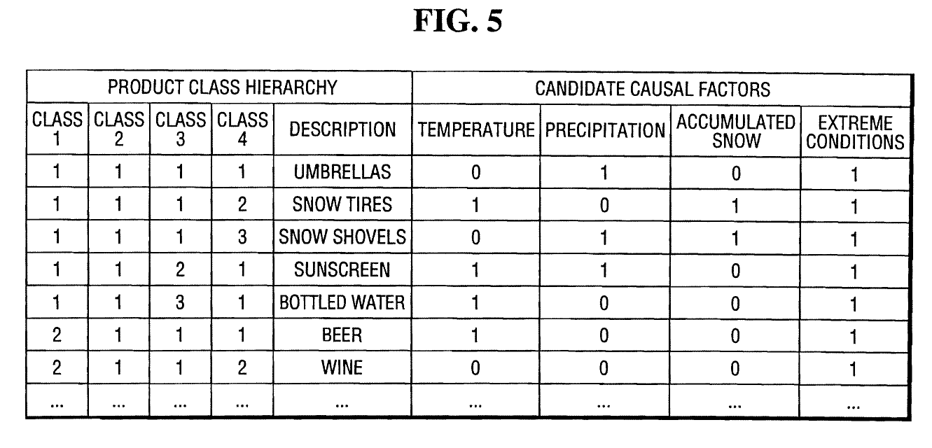

FIG. 6 is a flow chart illustrating a process for selecting causal variables to be used within a causal forecasting framework.

FIG. 7 shows the structure of a database table for storing causal variable history information during variable selection in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, the causal demand forecasting methodology seeks to establish a cause-effect relationship between product demand and factors influencing product demand in a market environment. A product demand forecast is generated by blending the various influencing factors in accordance with corresponding regression coefficients determined through the analysis of historical product demand and factor information. The multivariable regression equation can be expressed as:

y=b₀+b₁x₁+b₂x₂+ . . . +bₖxₖ (EQN 1);

where y represents demand; x₁ through xₖ represent causal variables, such as current product sales rate, seasonality of demand, product price, promotional activities, and other factors; and b₀ through bₖ represent regression coefficients determined through regression analysis using historical sales, price, promotion, and other causal data.

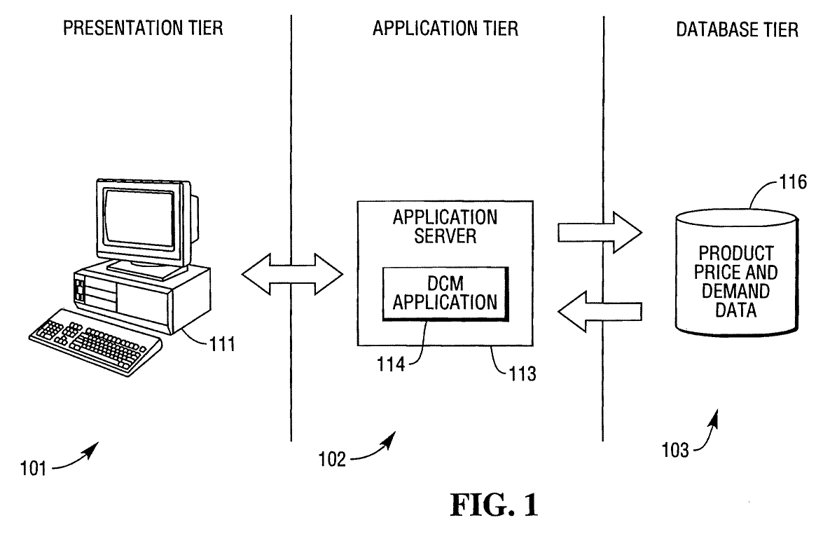

The Teradata Corporation DCM Application Suite may be implemented within a three-tier computer system architecture as illustrated in FIG. 1. The three-tier computer system architecture is a client-server architecture in which the user interface, application logic, and data storage and data access are developed and maintained as independent modules, most often on separate platforms. The three tiers are identified in FIG. 1 as presentation tier 101, application tier 102, and database access tier 103.

Presentation tier 101 includes a PC or workstation 111 and standard graphical user interface enabling user interaction with the DCM application and displaying DCM output results to the user. Application tier 103 includes an application server 113 hosting the DCM software application 114. Database tier 103 includes a database server containing a database 116 of product price and demand data accessed by DCM application 114.

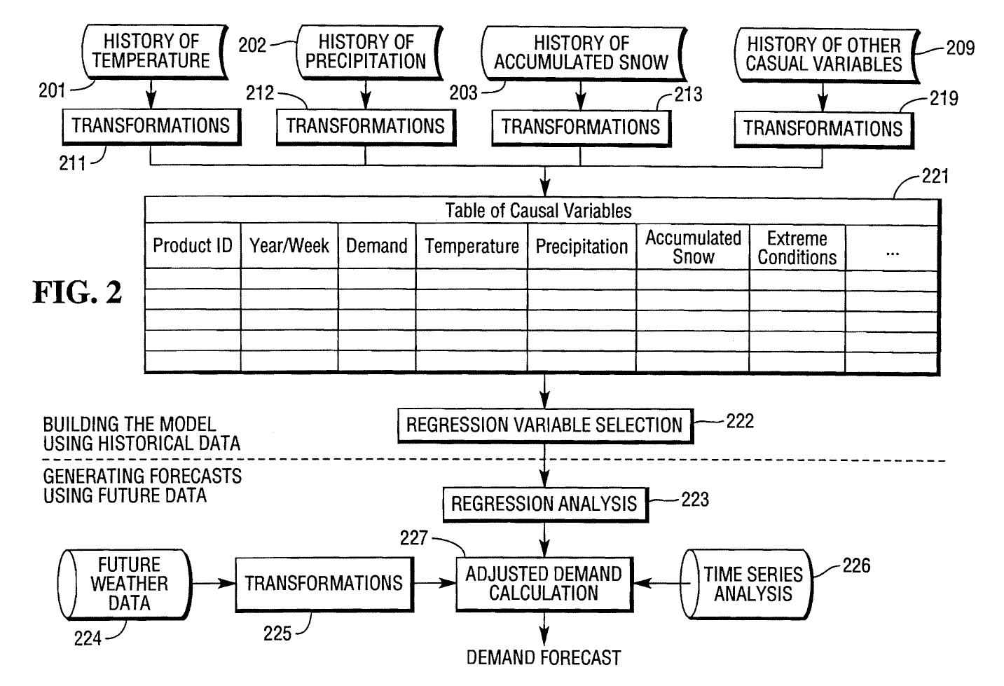

FIG. 2 is a flow diagram illustrating an improved causal methodology for determining product demand forecasts including weather related data as a set of causal factors within the regression analysis and demand forecast calculations. These weather related factors may include temperature, precipitation, snow, accumulated snow, or extreme weather conditions. It is known that the demand of some product categories is driven by such factors. For instance, the demand for umbrellas and snow tires are driven by precipitation and accumulated snow, respectively. However, no previously available methodology is known to effectively use weather related data in a causal demand forecasting system to improve demand forecast accuracy.

In the causal demand forecasting systems described herein, and illustrated in FIG. 2, both historical and future values of causal factors are needed for causal forecasting. Historical values are used to build the causal model, i.e., to determine the influence of the factor on demand of products, and future values are needed to generate the demand forecasts using the causal model. The future values of the causal factors should be either predictable or known in advance.

The historical values of weather data are readily available. Historical and predicted weather data can be purchased through subscription to a weather service or can be downloaded from established websites. Such data is normally collected at weather stations located at airports. Therefore, the location of a retailer employing a causal demand forecasting system including weather related data as a set of causal factors should be mapped to the closest airport or weather station where weather data is collected.

In FIG. 2, acquired historical temperature data, precipitation data, and accumulated snow data is represented by stored data 201, 202 and 203, respectively.

In steps 211, 212 and 213, stored historical temperature data 201, precipitation data 202, and accumulated snow data 203 is transformed into a format that can be fed into the DCM causal framework. For instance, the collected historical temperature is in the form of maximum, minimum, and average daily values. These values are transformed into weekly average temperatures based on the fiscal retail calendar. Other mathematical transformations may be required from case to case.

Additional weather-related historical casual factor data, not shown, may also be saved, transformed, and fed into the DCM causal framework. Other, non-weather-related, historical casual factor data, represented by stored data 209, is transformed in step 219, and fed into the DCM causal framework.

Causal factor data is compiled for each product or product category as shown by table 221. Table 221 illustrates the collection of weather related causal factor data, e.g., temperature, precipitation, accumulated snow data, and extreme conditions for a portion of a retailers product line, e.g., umbrellas, snow tires, snow shovels, sunscreen, and bottled water. The information displayed in table 221 comprises just a portion of the retailer's product line and a subset of all weather, and non-weather, related causal variables.

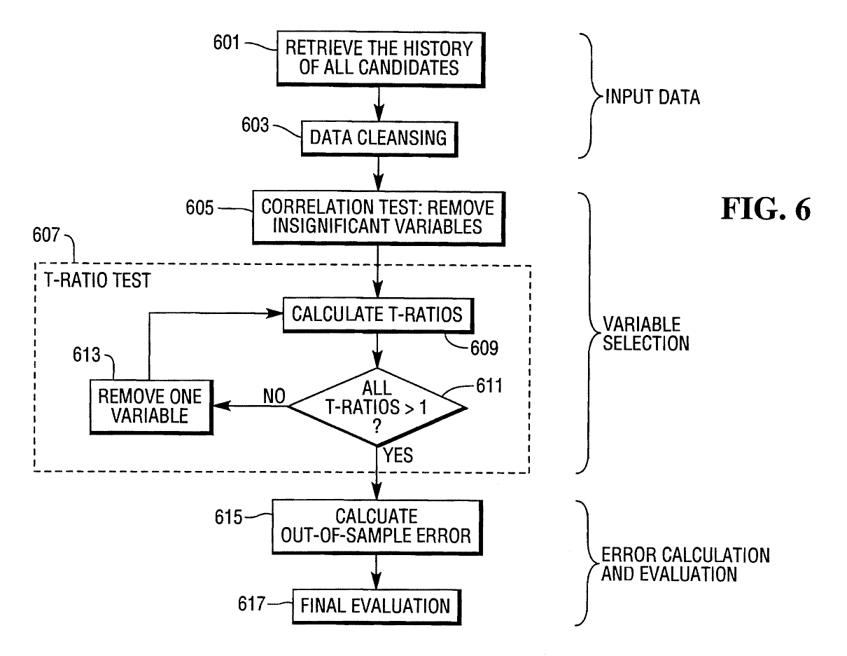

In step 222, causal factor historical data is examined to identify the set of causal weather factors, and other causal factors, that have statistically significant effects on historical product demand, and hence are believed to be of greatest relevance in determining product demand changes in the future, are identified. Additional detail regarding the process for selecting causal variables is illustrated in FIG. 6 and discussed below.

In step 223, regression analysis is performed to determine the regression coefficients for the variables selected in step 222, and to build the multivariable regression equation required for demand forecast calculation.

In step 226 of FIG. 2, the current weekly ARS for a product is calculated from historical demand data. In step 227, the product demand forecast is determined by blending the Average Rate of Sale (ARS) from step 226 with forecasted weather data factors 224, and other forecasted or known causal factor data, for the product demand forecast period multivariable regression equation required for demand forecast calculation.

Future weather data is generally predictable with sufficient accuracy up to one week into the future. The accuracy of such weather forecasts directly affects the accuracy of demand forecasts derived from the causal framework. A transformation 225 may be required to feed the future weather values into the DCM causal framework.

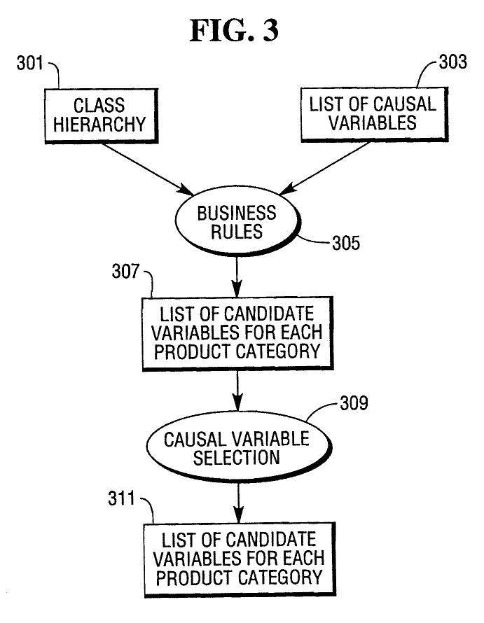

The causal demand forecasting systems described above, and illustrated in FIG. 2 can be applied at the product level or at any level of a retailer's product class hierarchy, assuming adequate sales and causal factory history is available. FIG. 3 illustrates a process for the selection of candidate variables for each category of products using business rules.

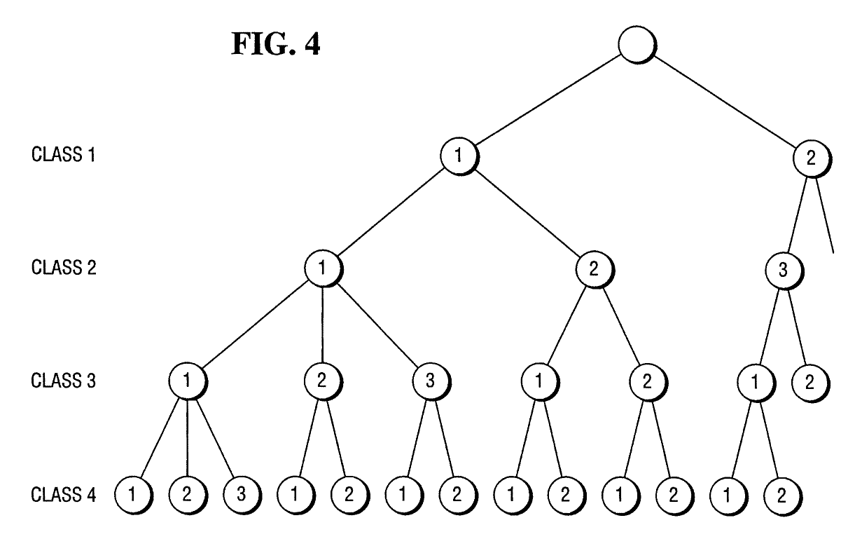

An exemplary product hierarchy is shown in FIG. 4. A product hierarchy is a database of all products organized sold by a retailer organized into categories and sub-categories. Five levels of a product hierarchy are illustrated, identified as CLASS 0 through CLASS 4, with each lower level in the hierarchy containing more specific product groupings. The topmost level of the hierarchy, CLASS 0, includes the broad product categories, such as departments within a store. The second level of the hierarchy, identified as CLASS 1, include more specific product groupings under the CLASS 0 category, while CLASS 2 and CLASS 3 provide even more specific product groupings. At the bottom of the hierarchy, CLASS 4 in FIG. 4, are very specific product descriptions. All products offered for sale by the retailer are represented within at least one of the lowest level merchandise class categories within the merchandise hierarchy.

Referring to FIG. 3, Business Rules 305 are applied to the product hierarchy 301 and causal factor historical data 303 to identify a list of candidate variables for each product and product group within the product hierarchy. For mathematical reasons, it is important to apply each causal factor to the relevant categories of products only. This is done using both business input and statistical tests. Rules 305 allow business users, e.g., store managers, to determine the relevant causal factors for a given category of products. The table of FIG. 6 shows a simplified output of this selection. These values are hypothetical and for illustration only.

Table 6 contains a listing of all product categories sold by a retailer under the heading “DESCRIPTION” and to the right of each listed product, the causal factors associated with each product, wherein a “0” in a product row and causal factor column indicates no relationship between sales of a product and a causal factor, and a “1” identifies a relationship between product sales and the causal factor. The columns to the left of the product descriptions identify the product groups within the class hierarchy to which each product belongs. Though use of this table associations between product groups and causal factors can be identified.

Referring again to FIG. 3, the list of candidate variables 307 is evaluated in step 309 to identify the set of causal factors that have statistically significant effects on historical product demand and provide a list of candidate variable 311 believed to be of greatest relevance in determining future product demand changes. Additional detail regarding the process for selecting causal variables is illustrated in FIG. 6 and discussed below.

Following the identification and selection of candidate variables for products or product groups, demand forecasting is completed as illustrated in FIG. 2 and described above.

Referring now to FIG. 6, the process for selecting causal variables will now be described. Initially, all causal variable candidates should be considered as some variables may be significant for some products or product groups but not for others.

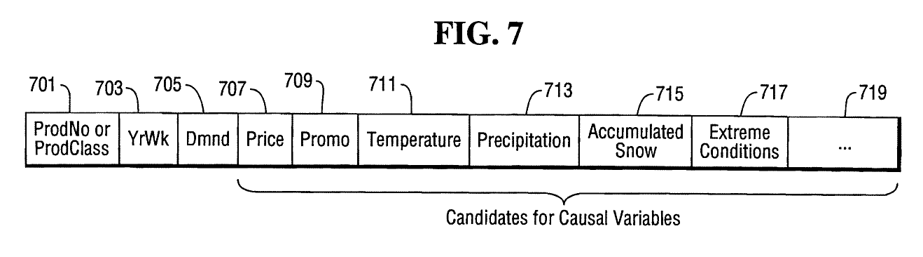

The process of FIG. 6 begins with the retrieval of historical sales data and causal factor data for a product or product group from data storage in step 601. The history of the product's demand (dependant variable) and all other variables (candidates) required for the selection analysis are stored in a table with one column per variable, as illustrated in FIG. 7. FIG. 7 shows one row of the table. Data stored within the table for each week of product demand includes: a product or product group identification, ProdNo 701; an identification of the week and year of the demand data, YrWk 703; the product or product group demand for the identified week, Dmnd 705; and causal variables Price 707 (calculated as total dollars/total demand), Promo 709, Temperature 711; Precipitation 713, Accumulated Snow 715, Extreme Conditions 717 and other causal variables 719. The causal variables identified in FIG. 7 are not intended to comprise a complete listing of possible variables.

In step 603 data cleansing is performed to remove product demand data corresponding to a stock-out condition, and to remove incomplete weeks, e.g., when the value of one or more variables is missing. In step 605 the correlation of demand with each of the causal variables is calculated. If the correlation is insignificant, the variable is removed from the regression equation.

In step 607, a multi-regression model is constructed with regression coefficients calculated for each of the causal factors that passed step 605. T-ratios are calculated for each coefficient (step 609) and the variables with smallest absolute t-ratios, are removed iteratively, until the absolute value of all t-ratios>1 (steps 611 and 613).

In step 615 an out-of-sample error calculation is performed to confirm that all the variables contribute to forecast accuracy, i.e., the accuracy is deteriorated if any of the variables is removed. It is recommended that the process be repeated with different variable sets to confirm that each variable is actually contributing to forecast accuracy.

A final evaluation to verify coefficient selection is performed in step 617. Tests are performed to verify that the amount of historical data is adequate to support the selection process, e.g. the number of complete weeks of history divided by the number of variables exceeds 20.

### Conclusion

The Figures and description of the invention provided above reveal an improved method and system for forecasting product demand using a causal methodology, based on multiple regression techniques. The improvement including weather related data as a set of causal factors for forecasting product demand using the causal methodology.

Instructions of the various software routines discussed herein, such as the methods illustrated in FIGS. 2 and 3 are stored on one or more storage modules in the system shown in FIG. 1 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A computer-implemented method for forecasting product demand for a product during a future sales period, the method comprising the steps of:
maintaining, on a computer, an electronic database of historical product demand information;
calculating, by said computer, an initial demand forecast for said product during said future sales period from said historical demand information;
identifying a plurality of weather-related causal factors influencing demand for said product;
receiving, at said computer, historical weather information;
analyzing, by said computer, said historical product demand information and said historical weather information to determine regression coefficients corresponding to said weather-related causal variables;
receiving, at said computer, forecast values for said weather-related causal variables during said future sales period;
blending, by said computer, said initial demand forecast, said regression coefficients and corresponding forecast values for said weather-related causal variables to determine a product demand forecast for said product.

2. The computer-implemented method according to claim 1, wherein said step of identifying a plurality of weather-related causal factors influencing demand for said product comprises the step of
analyzing, by said computer, said historical product demand information and said historical weather information to identify weather-related causal variables influencing demand for said product.

3. The computer-implemented method according to claim 1, wherein:
said step of identifying a plurality of weather-related causal factors influencing demand for said product comprises the step of analyzing, by said computer, said historical product demand information and said historical weather information to identify weather-related causal variables having statistically significant effects on the historical product demand for said product; and
said step of blending said initial demand forecast, said regression coefficients and corresponding forecast values for said weather-related causal variables to determine a product demand forecast for said product comprises blending said initial demand forecast, said regression coefficients and corresponding forecast values for said weather-related causal variables having statistically significant effects on the historical product demand for said product to determine said product demand forecast.

4. The computer-implemented method according to claim 1, wherein said step of analyzing, by said computer, said historical product demand information and said historical weather information to determine regression coefficients corresponding to said weather-related causal variables comprises analyzing, by said computer, said historical product demand information and said historical weather information for a product group including said product to determine regression coefficients corresponding to said weather-related causal variables.

5. The computer-implemented method according to claim 1, wherein said weather-related causal variables includes at least one of the following:
a temperature variable;
a precipitation variable;
a snow variable;
an accumulated snow variable; and
an extreme weather condition variable.

6. A system for forecasting product demand for a product during a future sales period, the system comprising:
a computer storage device containing a database of historical product demand information for a plurality of products; and
a processor for:
calculating an initial demand forecast for said product during said future sales period from said historical demand information;
receiving historical weather information;
analyzing said historical product demand information and said historical weather information to determine regression coefficients corresponding to a plurality of weather-related causal factors influencing demand for said product;
receiving forecast values for said weather-related causal variables during said future sales period; and
blending said initial demand forecast, said regression coefficients and corresponding forecast values for said weather-related causal variables to determine a product demand forecast for said product.

7. The system according to claim 6, wherein said processor analyzes said historical product demand information and said historical weather information to identify the weather-related causal variables influencing demand for said product.

8. The system according to claim 6, wherein:
said processor analyzes said historical product demand information and said historical weather information to identify weather-related causal variables having statistically significant effects on the historical product demand for said product; and
blending said initial demand forecast, said regression coefficients and corresponding forecast values for said weather-related causal variables to determine a product demand forecast for said product comprises blending said initial demand forecast, said regression coefficients and corresponding forecast values for said weather-related causal variables having statistically significant effects on the historical product demand for said product to determine said product demand forecast.

9. The system according to claim 6, wherein analyzing said historical product demand information and said historical weather information to determine regression coefficients corresponding to said weather-related causal variables comprises analyzing said historical product demand information and said historical weather information for a product group including said product to determine regression coefficients corresponding to said weather-related causal variables.

10. The system according to claim 6, wherein said weather-related causal variables includes at least one of the following:
a temperature variable;
a precipitation variable;
a snow variable;
an accumulated snow variable; and
an extreme weather condition variable.

11. A computer program, stored on a tangible storage medium, for forecasting demand for a product, the program including executable instructions that cause a computer to:
calculate an initial demand forecast for said product during said future sales period from historical demand information maintained within an electronic database on said computer;
receive historical weather information;
analyze said historical product demand information and said historical weather information to determine regression coefficients corresponding to a plurality of weather-related causal factors influencing demand for said product;
receive forecast values for said weather-related causal variables during said future sales period; and
blend said initial demand forecast, said regression coefficients and corresponding forecast values for said weather-related causal variables to determine a product demand forecast for said product.

12. The computer program, stored on a tangible storage medium, for forecasting demand for a product according to claim 11, wherein said executable instructions cause said computer to analyze said historical product demand information and said historical weather information to identify the weather-related causal variables influencing demand for said product.

13. The computer program, stored on a tangible storage medium, for forecasting demand for a product according to claim 11, wherein:
said executable instructions cause said computer to analyze said historical product demand information and said historical weather information to identify weather-related causal variables having statistically significant effects on the historical product demand for said product; and
blending said initial demand forecast, said regression coefficients and corresponding forecast values for said weather-related causal variables to determine a product demand forecast for said product comprises blending said initial demand forecast, said regression coefficients and corresponding forecast values for said weather-related causal variables having statistically significant effects on the historical product demand for said product to determine said product demand forecast.

14. The computer program, stored on a tangible storage medium, for forecasting demand for a product according to claim 11, wherein analyzing said historical product demand information and said historical weather information to determine regression coefficients corresponding to said weather-related causal variables comprises analyzing said historical product demand information and said historical weather information for a product group including said product to determine regression coefficients corresponding to said weather-related causal variables.

15. The computer program, stored on a tangible storage medium, for forecasting demand for a product according to claim 11, wherein said weather-related causal variables includes at least one of the following:
a temperature variable;
a precipitation variable;
a snow variable;
an accumulated snow variable; and
an extreme weather condition variable.
